(19) United States
(12) Patent Application Publication
(10) Pub. No.: US 2025/0132875 A1
(43) Pub. Date: Apr. 24, 2025

(54) Channel State Information Reference Signal Transmission and Measurement for Reduced Capability Wireless Device Operation

(71) Applicant: Apple Inc., Cupertino, CA (US)

(72) Inventors: Hong He, Cupertino, CA (US); Seyed Ali Akbar Fakoorian, San Diego, CA (US); Yushu Zhang, Beijing (CN); Weidong Yang, San Diego, CA (US); Wei Zeng, San Diego, CA (US); Sigen Ye, San Diego, CA (US); Dawei Zhang, Saratoga, CA (US); Haitong Sun, Cupertino, CA (US); Chunxuan Ye, San Diego, CA (US); Jie Cui, San Jose, CA (US)

(21) Appl. No.: 18/835,633

(22) PCT Filed: Mar. 25, 2022
(86) PCT No.: PCT/CN2022/082945

§ 371 Date: Aug. 2, 2024

(51) Int. Cl. H04L 5/00

(52) U.S. Cl. CPC H04L 5/0048

(57) ABSTRACT

This disclosure relates to techniques for providing channel state information reference signals for a reduced capability wireless device in a wireless communication system. A wireless device and a cellular base station may establish a wireless link. Channel state information acquisition for a bandwidth part may be configured for the wireless device. The wireless device may determine channel state information reference signal resources for the channel state information acquisition. The channel state information reference signal resources may include multiple resource elements per antenna port per physical resource block for the bandwidth part. The wireless device may perform channel state information acquisition using the channel state information reference signal resources.

### FIELD

The present application relates to wireless communications, and more particularly to systems, apparatuses, and methods for providing channel state information reference signals for a reduced capability wireless device in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1xRTT, 1xEV-DO, HRPD, eHRPD), IEEE 802.11 (WLAN or Wi-Fi), BLUETOOTH™, etc.

The ever-increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is very important to also reduce power requirements in UE device designs while allowing the UE device to maintain good transmit and receive abilities for improved communications. Accordingly, improvements in the field are desired.

### SUMMARY

Embodiments are presented herein of apparatuses, systems, and methods for providing channel state information reference signals for a reduced capability wireless device in a wireless communication system.

The techniques described herein may include provision of channel state information reference signal resources that include multiple resource elements per antenna port per physical resource block for use for channel state information acquisition for a reduced capability wireless device. Such use of an increased density of resource elements per antenna port may help improve the spectral efficiency and modulation and coding scheme that can be used by the reduced capability wireless device. For example, for a reduced capability device that operates in a relatively small operating bandwidth and/or with relatively few antenna elements, the increased density of channel state information resources per antenna element may increase channel state information measurement accuracy. In such a manner, it may be possible to obtain comparable performance to that achievable by normal capability devices with fewer channel state information resources per antenna element but greater operating bandwidth and/or more available antenna ports, at least in some instances.

Numerous possible designs can be used to provide multiple resource elements per antenna port per physical resource block for channel state information acquisition for a reduced capability wireless device. Some possibilities can include use of one or more one port channel state information resources with density greater than one, use of a multi-port channel state information resource pattern with repetition configured for the pattern, use of multiple multi-port channel state information resources, or use of an existing channel state information reference signal resource mapping technique to indicate number and location of resource elements together with use of a new antenna port number parameter to indicate number of antenna ports for the channel state information acquisition.

Techniques are also described herein for supporting configuration of channel state information acquisition for deactivated (as well as for active) bandwidth parts, and for configuration of subband channel state information acquisition for relatively small subband sizes, at least for reduced capability wireless devices.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 is a flowchart diagram illustrating aspects of an exemplary possible method for providing channel state information reference signals for a reduced capability wireless device in a wireless communication system, according to some embodiments;

FIGS. 6-7 are CDFs illustrating possible spectral efficiency and modulation and coding scheme performance at various signal to noise ratio values for each of various channel state information measurement bandwidths, according to some embodiments;

FIG. 8 illustrates aspects of a scenario in which a reduced capability wireless device could be operating with a bandwidth below a normal bandwidth threshold for channel state information reference signals, according to some embodiments;

FIGS. 9-11 illustrate various possible aspects of a channel state information reference signal design approach in which one port channel state information reference signal resources with density greater than one are used, according to some embodiments;

FIGS. 12-14 illustrate various possible aspects of a channel state information reference signal design approach in which a multi-port channel state information reference signal pattern with repetition is used, according to some embodiments;

FIGS. 15-16 illustrate various possible aspects of a channel state information reference signal design approach in which a multiple multi-port channel state information reference signal resources are used, according to some embodiments;

FIG. 17 illustrates various possible aspects of another channel state information reference signal design approach, according to some embodiments; and

FIG. 18 illustrates exemplary aspects of a possible technique for configuring channel state information acquisition for a deactivated bandwidth part, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
RF: Radio Frequency
BS: Base Station
GSM: Global System for Mobile Communication
UMTS: Universal Mobile Telecommunication System.
LTE: Long Term Evolution
NR: New Radio
TX: Transmission/Transmit
RX: Reception/Receive
RAT: Radio Access Technology
TRP: Transmission-Reception-Point
DCI: Downlink Control Information
CORESET: Control Resource Set
QCL: Quasi-Co-Located or Quasi-Co-Location
CSI: Channel State Information
CSI-RS: Channel State Information Reference Signals
CQI: Channel Quality Indicator
PMI: Precoding Matrix Indicator
RI: Rank Indicator

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

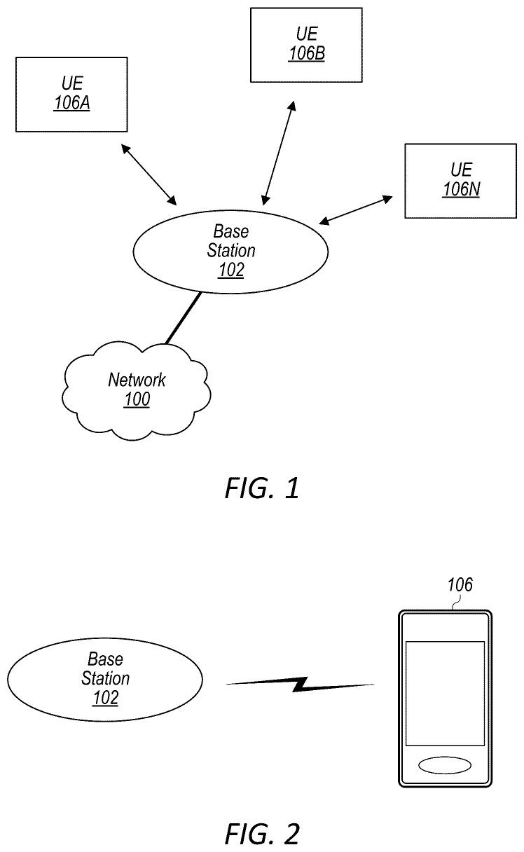

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1xRTT, 1xEV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform techniques for utilizing channel state information reference signals for a reduced capability wireless device in a wireless communication system, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for multiple-input, multiple-output or “MIMO”) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include any number of antennas and may be configured to use the antennas to transmit and/or receive directional wireless signals (e.g., beams). Similarly, the BS 102 may also include any number of antennas and may be configured to use the antennas to transmit and/or receive directional wireless signals (e.g., beams). To receive and/or transmit such directional signals, the antennas of the UE 106 and/or BS 102 may be configured to apply different “weight” to different antennas. The process of applying these different weights may be referred to as “precoding”.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1xRTT (or LTE or NR, or LTE or GSM), and separate radios for communicating using each of Wi-Fi and BLUETOOTH™. Other configurations are also possible.

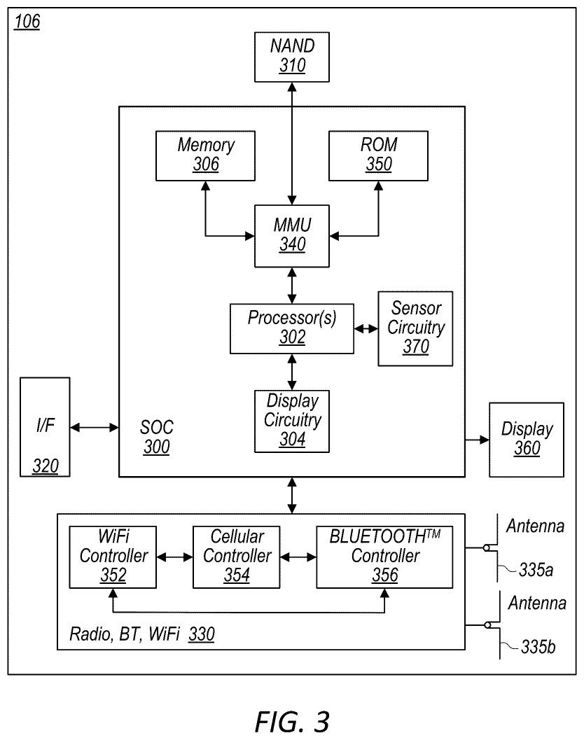

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. The communication circuitry may include multiple receive chains and/or multiple transmit chains for receiving and/or transmitting multiple spatial streams, such as in a multiple-input multiple output (MIMO) configuration. As noted above, the UE may be configured to communicate wirelessly using multiple wireless communication standards in some embodiments.

The UE 106 may include hardware and software components for implementing methods for the UE 106 to utilize channel state information reference signals for a reduced capability wireless device in a wireless communication system, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to utilize channel state information reference signals for a reduced capability wireless device in a wireless communication system according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

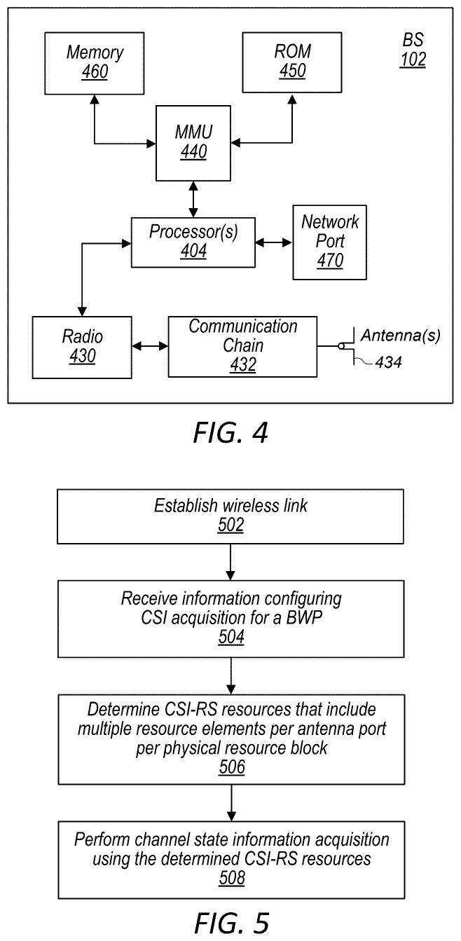

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNBs.

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, 5G NR, 5G NR SAT, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, 5G NR SAT and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g., it may include at least one Ethernet port, and radio 430 may be designed to communicate according to the Wi-Fi standard.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

### Reference Signals

A wireless device, such as a user equipment, may be configured to perform a variety of tasks that include the use of reference signals (RS) provided by one or more cellular base stations. For example, initial access and beam measurement by a wireless device may be performed based at least in part on synchronization signal blocks (SSBs) provided by one or more cells provided by one or more cellular base stations within communicative range of the wireless device. Another type of reference signal commonly provided in a cellular communication system may include channel state information (CSI) RS. Various types of CSI-RS may be provided for tracking (e.g., for time and frequency offset tracking), beam management (e.g., with repetition configured, to assist with determining one or more beams to use for uplink and/or downlink communication), and/or channel measurement (e.g., CSI-RS configured in a resource set for measuring the quality of the downlink channel and reporting information related to this quality measurement to the base station), among various possibilities. For example, in the case of CSI-RS for CSI acquisition, the UE may periodically perform channel measurements and send channel state information (CSI) to a BS. The base station can then receive and use this channel state information to determine an adjustment of various parameters during communication with the wireless device. In particular, the BS may use the received channel state information to adjust the coding of its downlink transmissions to improve downlink channel quality.

In many cellular communication systems, the base station may transmit some or all such reference signals (or pilot signals), such as SSB and/or CSI-RS, on a periodic basis. In some instances, aperiodic reference signals (e.g., for aperiodic CSI reporting) may also or alternatively be provided.

As a detailed example, in the 3GPP NR cellular communication standard, the channel state information fed back from the UE based on CSI-RS for CSI acquisition may include one or more of a channel quality indicator (CQI), a precoding matrix indicator (PMI), a rank indicator (RI), a CSI-RS Resource Indicator (CRI), a SSBRI (SS/PBCH Resource Block Indicator, and a Layer Indicator (LI), at least according to some embodiments.

The channel quality information may be provided to the base station for link adaptation, e g., for providing guidance as to which modulation & coding scheme (MCS) the base station should use when it transmits data. For example, when the downlink channel communication quality between the base station and the UE is determined to be high, the UE may feed back a high CQI value, which may cause the base station to transmit data using a relatively high modulation order and/or a low channel coding rate. As another example, when the downlink channel communication quality between the base station and the UE is determined to be low, the UE may feed back a low CQI value, which may cause the base station to transmit data using a relatively low modulation order and/or a high channel coding rate.

PMI feedback may include preferred precoding matrix information, and may be provided to a base station in order to indicate which MIMO precoding scheme the base station should use In other words, the UE may measure the quality of a downlink MIMO channel between the base station and the UE, based on a pilot signal received on the channel, and may recommend, through PMI feedback, which MIMO precoding is desired to be applied by the base station. In some cellular systems, the PMI configuration is expressed in matrix form, which provides for linear MIMO precoding. The base station and the UE may share a codebook composed of multiple precoding matrixes, where each MIMO precoding matrix in the codebook may have a unique index Accordingly, as part of the channel state information fed back by the UE, the PMI may include an index (or possibly multiple indices) corresponding to the most preferred MIMO precoding matrix (or matrixes) in the codebook. This may enable the UE to minimize the amount of feedback information. Thus, the PMI may indicate which precoding matrix from a codebook should be used for transmissions to the UE, at least according to some embodiments.

The rank indicator information (RI feedback) may indicate a number of transmission layers that the UE determines can be supported by the channel, e.g., when the base station and the UE have multiple antennas, which may enable multi-layer transmission through spatial multiplexing. The RI and the PMI may collectively allow the base station to know which precoding needs to be applied to which layer, e.g., depending on the number of transmission layers.

In some cellular systems, a PMI codebook is defined depending on the number of transmission layers. In other words, for R-layer transmission, N number of Nₜ×R matrixes may be defined (e.g, where R represents the number of layers, Nₜ represents the number of transmitter antenna ports, and N represents the size of the codebook). In such a scenario, the number of transmission layers (R) may conform to a rank value of the precoding matrix (Nₜ×R matrix), and hence in this context R may be referred to as the “rank indicator (RI)”.

Thus, the channel state information may include an allocated rank (e.g., a rank indicator or RI). For example, a MIMO-capable UE communicating with a BS may include four receiver chains, e.g., may include four antennas. The BS may also include four or more antennas to enable MIMO communication (e.g., 4×4 MIMO). Thus, the UE may be capable of receiving up to four (or more) signals (e.g., layers) from the BS concurrently. Layer to antenna mapping may be applied, e.g., each layer may be mapped to any number of antenna ports (e.g., antennas). Each antenna port may send and/or receive information associated with one or more layers. The rank may include multiple bits and may indicate the number of signals that the BS may send to the UE in an upcoming time period (e.g., during an upcoming transmission time interval or TTI). For example, an indication of rank 4 may indicate that the BS will send 4 signals to the UE. As one possibility, the RI may be two bits in length (e.g., since two bits are sufficient to distinguish 4 different rank values). Note that other numbers and/or configurations of antennas (e.g., at either or both of the UE or the BS) and/or other numbers of data layers are also possible, according to various embodiments.

### FIG. 5—Channel State Information Reference Signal Transmission and Measurement for Reduced Capability Wireless Device Operation

According to at least some cellular communication technologies, it may be possible to accommodate wireless devices of varying capabilities. Such accommodation can include using different designs for certain features for devices with differing capabilities. One example of such differing designs could include support for a category of “reduced capability” (or “RedCap”) devices in addition to support for a category of “normal capability” devices. Communication with reduced capability devices according to a cellular communication technology with such support could be limited to a lower maximum bandwidth than other communication according to the cellular communication technology, for example, which could potentially facilitate the possibility of lower complexity (and potentially correspondingly reduced cost and/or reduced power consumption) devices being able to effectively use the cellular communication technology.

In some instances, in order to support use of certain modified features for wireless communication with reduced capability devices, it may be beneficial or potentially necessary to modify other aspects of the wireless communication in addition to and possibly in conjunction with those features.

For example, for reduced capability wireless communication designs for 3GPP 5G NR based wireless communication systems, it might be the case that use of existing channel state information reference signal design for smaller operating bandwidths could provide significantly worse performance than for larger operating bandwidths. Accordingly, to effectively support a communication framework for reduced capability wireless devices that uses such a smaller operating bandwidth, it may be beneficial to provide alternative reference signal design options that can support good performance at those smaller operating bandwidths.

Thus, it may be beneficial to provide such techniques for channel state information reference signal transmission and measurement for reduced capability wireless devices, at least in some scenarios. To illustrate one such set of possible techniques, FIG. 5 is a flowchart diagram illustrating a method for providing channel state information reference signals for a reduced capability wireless device in a wireless communication system, at least according to some embodiments.

Aspects of the method of FIG. 5 may be implemented by a wireless device, e.g., in conjunction with one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 5 are described in a manner relating to the use of communication techniques and/or features associated with 3GPP and/or NR specification documents, such description is not intended to be limiting to the disclosure, and aspects of the method of FIG. 5 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 5 may operate as follows.

In 502, a wireless device and a cellular base station may establish a wireless link. According to some embodiments, the wireless link may include a cellular link according to 5G NR. For example, the wireless device may establish a session with an AMF entity of a cellular network by way of one or more gNBs that provide radio access to the cellular network. As another possibility, the wireless link may include a cellular link according to LTE. For example, the wireless device may establish a session with a mobility management entity of a cellular network by way of an eNB that provides radio access to the cellular network. Other types of cellular links are also possible, and the cellular network may also or alternatively operate according to another cellular communication technology (e.g., UMTS, CDMA2000, GSM, etc.), according to various embodiments.

Establishing the wireless link may include establishing a RRC connection with a serving cellular base station, at least according to some embodiments. Establishing the RRC connection may include configuring various parameters for communication between the wireless device and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device may operate in a RRC connected state. In some instances, the RRC connection may also be released (e.g., after a certain period of inactivity with respect to data communication), in which case the wireless device may operate in a RRC idle state or a RRC inactive state. In some instances, the wireless device may perform handover (e.g., while in RRC connected mode) or cell re-selection (e.g., while in RRC idle or RRC inactive mode) to a new serving cell, e.g., due to wireless device mobility, changing wireless medium conditions, and/or for any of various other possible reasons.

At least according to some embodiments, the wireless device may establish multiple wireless links, e.g., with multiple TRPs of the cellular network, according to a multi-TRP configuration. In such a scenario, the wireless device may be configured (e.g., via RRC signaling) with one or more transmission control indicators (TCIs), e.g., which may correspond to various beams that can be used to communicate with the TRPs. Further, it may be the case that one or more configured TCI states may be activated by media access control (MAC) control element (CE) for the wireless device at a particular time.

At least in some instances, establishing the wireless link(s) may include the wireless device providing capability information for the wireless device. Such capability information may include information relating to any of a variety of types of wireless device capabilities. In some instances, the capability information could indicate that the wireless device is categorized as a reduced capability device, for example as a “RedCap” or “eRedCap” device according to 3GPP 5G NR, at least as one possibility.

In some instances, establishing the wireless link may include configuration of one or more bandwidth parts, each of which may include part or all of a component carrier on which the cellular base station operates. It may be the case that multiple BWPs can be configured, which may include active and inactive or deactivated BWPs.

In 504, the wireless device may receive information configuring channel state information (CSI) acquisition for a BWP. The BWP for which the CSI acquisition is configured may include an active BWP or a deactivated BWP, at least according to some embodiments. For instance, a ‘target BWP ID’ information element (IE) may be included in a downlink control information transmission to identify the BWP for which the CSI request is targeted. As another possibility, it may be the case that for each CSI reporting configuration, a ‘target BWP ID’ IE may be included to indicate the associated BWP for the CSI reporting that is associated with a given CSI request IE state, e.g., such that the target BWP is implicitly identified by the CSI request itself. Providing the capability to configure CSI acquisition for a deactivated BWP may be particularly useful for a reduced capability wireless device operating in a relatively small bandwidth, as such measurements may be helpful to enable the cellular network to efficiently switch such a device to a more suitable BWP (e.g., when such a switch is expected to be beneficial, such as to improve spectral efficiency), at least in some embodiments.

The CSI acquisition may be a subband CSI, at least in some instances. For example, it may be possible that a reduced capability wireless device can be configured via higher layer signaling (e.g., RRC or MAC) with a subband size (e.g., 4 PRBs or 8 PRBs, as some possibilities), potentially even for a BWP with a relatively small bandwidth (e.g., with fewer than 24 PRBs), at least according to some embodiments. At least according to some embodiments, providing support for CSI reporting for such relatively small subband sizes may be particularly useful for a reduced capability device that may commonly operate with relatively low data rates and transport block sizes, and that may correspondingly commonly not even occupy the entire (e.g., already relatively small) BWP for the reduced capability wireless device.

In 506, the wireless device may determine CSI reference signal resources for the CSI acquisition. The CSI-RS resources may include multiple resource elements per antenna port per physical resource block (PRB) for the BWP. This may contrast with at least some existing CSI-RS designs for CSI acquisition, for example which may include designs with one resource element per antenna port per PRP for a BWP. This increased density of CSI-RS resources used for CSI acquisition may help improve spectral efficiency and modulation and coding scheme performance for a reduced capability wireless device operating in a relatively low bandwidth BWP, at least according to some embodiments.

There may be multiple possible design options that can provide multiple resource elements per antenna port per PRB for a BWP. As one possibility, a design in which one or more 1-port CSI-RS resources with density greater than one (e.g., ρ=3, as one possibility) may be configured in the information configuring the CSI acquisition for the BWP can be used. If multiple such 1-port CSI-RS resources are configured (e.g., a CSI-RS resource set), it may be possible that repetition is enabled or is disabled, e.g., using a ‘repetition’ parameter that may be included in the information configuring the CSI acquisition for the BWP. If repetition is enabled, the same antenna port may be used for all of the CSI-RS resources for the CSI acquisition. If repetition is not enabled (e.g., is disabled), different antenna ports may be used for different CSI-RS resources for the CSI acquisition. In such a scenario, there may further be multiple possible approaches to determining which antenna port is configured for which CSI-RS resource of the CSI-RS resources configured for the CSI acquisition.

As one such possibility, the antenna port configured for a given CSI-RS resource may be determined based at least in part on the CSI-RS resource index for the CSI-RS resource within the CSI-RS resource set. For example, a first antenna port may be used for even CSI-RS resource index values and a second antenna port may be used for odd CSI-RS resource index values. Thus, for a scenario with 2 CSI-RS resources, CSI-RS resource index 0 would be configured with the first antenna port and CSI-RS resource index 1 would be configured with the second antenna port. Similarly, for a scenario with 4 CSI-RS resources, CSI-RS resource indexes 0 and 2 would be configured with the first antenna port and CSI-RS resource indexes 1 and 3 would be configured with the second antenna port.

As another possibility, the CSI-RS resource elements may be ordered (e.g., first in order of increasing frequency domain then in order of increasing time domain, or vice versa, among various possibilities) and correspondingly indexed, and the antenna port configured for a given CSI-RS resource element may be determined based at least in part on the resulting CSI-RS resource element index for that resource element. For example, a first antenna port may be used for even CSI-RS resource element index values and a second antenna port may be used for odd CSI-RS resource element index values.

Another design option that can provide multiple resource elements per antenna port per PRB for a BWP may include configuring a multi-port CSI-RS pattern with repetition configured the frequency domain and/or the time domain. The number of repetitions can be configured explicitly; for example, an indication of a number of repetitions for the multi-port CSI-RS pattern may be included in the information configuring the CSI acquisition for the BWP. As another possibility, the number of repetitions may be determined implicitly. For example, 3GPP standard specifications may fix the number of repetitions for a CSI-RS for reduced capability wireless devices (e.g., as 2, 3, or any of various other possible values). In such a scenario, the wireless device may be able to determine the number of repetitions based on its operating as a reduced capability category of wireless device.

The repetitions for the multi-port CSI-RS pattern may be provided at a frequency offset and/or a time offset relative to the configured multi-port CSI-RS pattern. In some embodiments, the offset(s) may be explicitly indicated in the information configuring the CSI acquisition for the BWP. As another possibility, the offset(s) may be implicitly determined, e.g., based on the number of repetitions configured for the multi-port CSI-RS pattern. For example, the frequency offset (e.g., if the repetitions are configured for different subcarriers of a PRB than the multi-port CSI-RS pattern) may be determined as 12 (e.g., the number of subcarriers in the PRB) divided by the number of repetitions, as one possibility. As another example, the time offset (e.g., if the repetitions are configured for different symbols of a PRB than the multi-port CSI-RS pattern) may be determined as 12 (e.g., the number of symbols in the PRB, excluding two symbols reserved for downlink control channels) divided by the number of repetitions, as one possibility. Note that as the repetitions can be configured in either or both of the time domain or the frequency domain, it may be possible that the repetitions are configured for the same symbol but different subcarriers than the multi-port CSI-RS pattern, or for the same subcarriers but different symbols than the multi-port CSI-RS pattern, or for both different subcarriers and different symbols than the multi-port CSI-RS pattern. Note that it may be the case that a mod (e.g., mod 12) operation is used when determining the CSI-RS resource elements on which the multi-port CSI-RS pattern is repeated, e.g., to avoid the possibility that the configured offset would place them in a different PRB and/or slot, and to instead ‘wrap-around’ the determined resource elements back to the same PRB and slot, if applicable.

A still further design option that can provide multiple resource elements per antenna port per PRB for a BWP may include directly configuring multiple multi-port CSI-RS resources. Such an approach may include providing information that explicitly indicates resource locations for the multiple multi-port CSI-RS resources in the information configuring the CSI acquisition. Such an approach may allow for greater flexibility with respect to which resources are configured for the CSI-RS, though greater signaling overhead may be needed to achieve such greater flexibility. It may be the case that a reduced capability wireless device can assume that the antenna ports across all of the multi-port CSI-RS resources are quasi co-located (e.g., with QCL Type A, Type D (when applicable), and average gain).

Yet another possible design option for providing multiple resource elements per antenna port per PRB for a BWP may include using an existing CSI-RS resource mapping IE to indicate the total number and location of resource elements for the CSI-RS resources for the CSI acquisition (e.g., ignoring the antenna port mapping associated with the CSI-RS resource mapping IE), and using a new antenna port number IE to indicate the number of antenna ports configured for the CSI-RS resources for the CSI acquisition. In some instances, the cdm-Type of antenna ports to be used by reduced capability wireless devices may also be indicated by an IE. Such IEs may be included in the information configuring the CSI acquisition for the BWP. The wireless device may be able to determine which antenna port to associate with which resource element by dividing the configured total number of resource elements by the configured number of antenna ports to determine a number of sub-groups, where each sub-group can effectively function as a 1-port or multi-port CSI-RS resource.

In 508, the wireless device may perform CSI acquisition using the determined CSI-RS resources. The CSI acquisition may include performing CSI measurements on the determined CSI-RS resources. The CSI-RS resources may be aggregated for a single CSI computation, at least according to some embodiments. The wireless device may also perform CSI reporting based on the CSI acquisition for the BWP, e.g., including providing the acquired CSI information as feedback to the cellular base station.

Thus, at least according to some embodiments, the method of FIG. 5 may be used to provide a framework according to which a reduced capability wireless device can be configured to perform channel state information measurements and reporting, and thus to assist a cellular network to effectively and efficiently schedule and perform wireless communications with such a category of wireless device, at least in some instances.

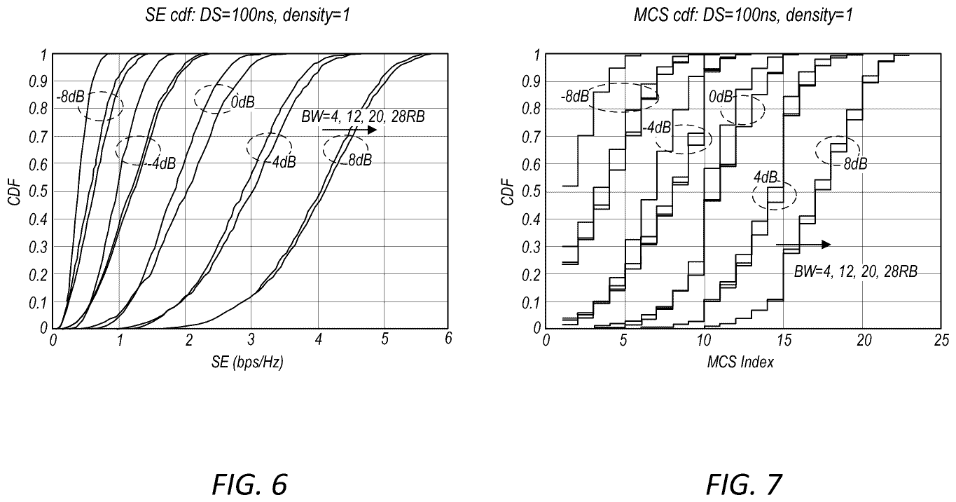

### FIGS. 6-18 and Additional Information

FIGS. 6-18 illustrate further aspects that might be used in conjunction with the method of FIG. 5 if desired. It should be noted, however, that the exemplary details illustrated in and described with respect to FIGS. 6-8 are not intended to be limiting to the disclosure as a whole: numerous variations and alternatives to the details provided herein below are possible and should be considered within the scope of the disclosure.

3GPP has established a framework in Release 17 for enabling reduced capability (RedCap) NR devices suitable for a range of use cases, with further enhancements possible for Release 18 and beyond (e.g., “enhanced RedCap” or “eRedCap”). The use cases could include industrial sensors, video surveillance devices, wearable devices, and/or various other use cases, with potential emphasis on supporting the possibility for relatively low UE complexity and/or relatively low UE power consumption.

In some embodiments, support for reduced capability may include relatively low peak data rates and/or relatively low bandwidth communication techniques to facilitate UE complexity reduction. For example, a framework for wireless communication with reduced capability devices could include a target peak data rate of 10 Mbps, a bandwidth target of 5 MHz in 3GPP frequency range 1 (FR1), a relaxed UE processing timeline for PDSCH and/or PUSCH and/or CSI, and/or various possible categories for various use cases such as industrial wireless communication, video surveillance with “economic” video, or video surveillance with “high-end” video, among various possibilities.

Since Release 15, it has generally been considered that spectral efficiency (SE) and modulation and coding scheme (MCS) loss for bandwidths with fewer than 24 PRBs may be higher than desired when the existing design for CSI-RS is used. For example, FIGS. 6-7 illustrate possible simulation results for different numbers of PRBs for CSI-RS and the associated spectral efficiency and modulation and coding scheme losses in scenarios with various signal to noise ratio values. As can be seen, CSI-RS transmission bandwidth values smaller than 20 PRBs yield a clear SE/MCS loss in the illustrated example, in particular in scenarios with poor signal conditions.

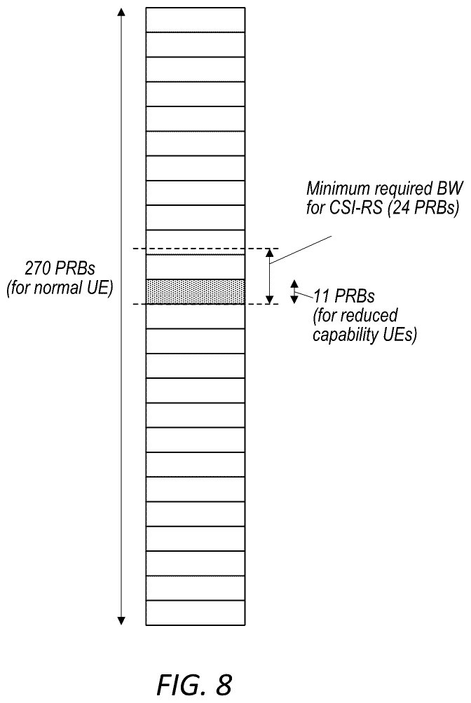

At least in some instances, a 5 MHz bandwidth in a NR framework may include 25 physical resource blocks (PRBs) with 15 kHz subcarrier spacing (SCS) and 11 PRBs with 30 kHz SCS. In other words, as illustrated in FIG. 8, reduced capability wireless devices operating with such a bandwidth may be below the minimum required bandwidth for CSI-RS for non-reduced capability devices. Thus, in a scenario in which a reduced capability device is operating in a 5 MHz bandwidth with 30 kHz SCS and correspondingly with 11 PRBs, it may be the case that use of the existing CSI-RS framework could result in undesired performance loss.

Accordingly, it may be desirable to provide possible alternative design options for a CSI-RS framework for communication with reduced capability devices that may possibly operate in a 5 MHz bandwidth with 30 kHz SCS and correspondingly with 11 PRBs, which can potentially provide better SE/MCS performance than the existing CSI-RS framework.

Another consideration for such a framework may include that in the current NR specification, for bandwidth part sizes of less than 24 PRBs, it may be the case that only wideband (WB) CSI reporting is supported. For at least some target use cases for reduced capability devices (e.g., industrial sensors, as one possibility), the data rate and transport block size (TBS) may be relatively small and may not be expected to occupy an entire reduced capability BWP. Accordingly, it may be the case that support of wideband CSI reporting only could significantly degrade the link adaptation performance for reduced capability UEs and cause spectral efficiency loss.

A still further consideration may include that, currently, NR may only support CSI measurement and reporting or channel sounding within an active BWP. At least in some instances, a reduced capability wireless device operating bandwidth may occupy a relatively small portion of an entire component carrier bandwidth (e.g., 11 PRBs out of 270 total PRBs, as one possibility, or 4% of component carrier bandwidth). Thus, without CSI information on the other parts of the component carrier bandwidth, it may be difficult for a gNB to efficiently switch a reduced capability UE to a suitable BWP to improve spectral efficiency. Accordingly, enhancements to provide the possibility for CSI acquisition outside the active bandwidth part may be useful to achieve a high spectral efficiency for services to reduced capability devices, at least according to some embodiments.

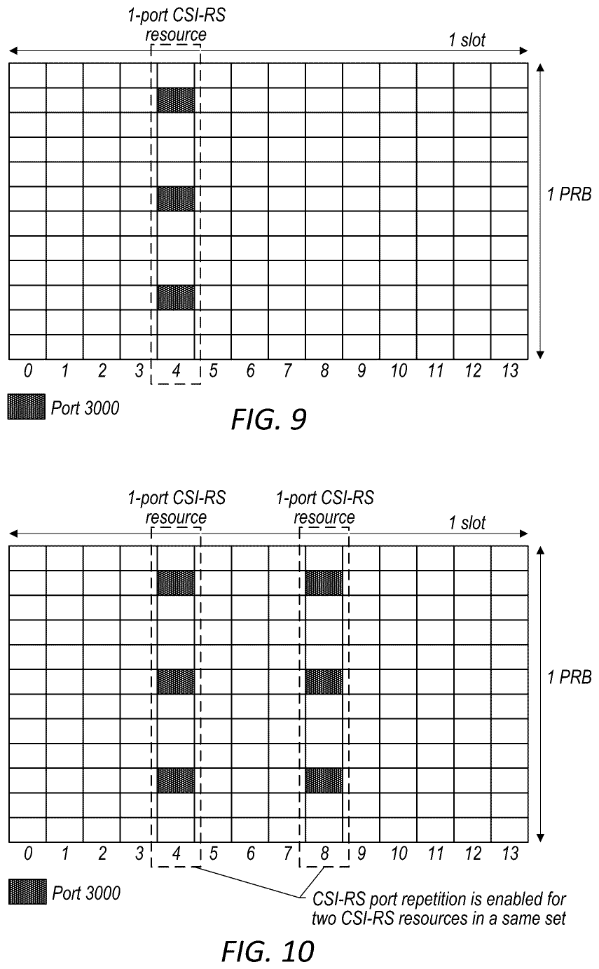

One possible approach to a CSI-RS pattern for reduced capability UEs could include use of a tracking reference signal (TRS) based design for the CSI-RS. FIGS. 9-11 illustrate various possible aspects of such a design approach, according to some embodiments. In 3GPP Release 15, a single port reference signal pattern limited to use for timing and frequency tracking purposes was introduced. For reduced capability UEs, it may be possible for a 1-port CSI-RS with density ρ=3 to be used for CSI acquisition. In some designs, a CSI-RS set may be configured for CSI acquisition for a reduced capability UE, which includes one or more than one 1-port CSI-RS with density ρ=3. When more than one 1-port CSI-RS resource is configured, a new parameter ‘repetition’ may be introduced for a CSI-RS resource set, which can be defined in the following manner, at least as one possibility. When ‘repetition’ is enabled, a same port index (e.g., port 3000) is configured for each 1-port CSI-RS resource and can be jointly used for CSI acquisition. When ‘repetition’ is disabled, different port indexes (e.g., port 3000 or port 3001) are configured for different 1-port CSI-RS resources in a same CSI-RS resource set. FIG. 9 illustrates an example CSI-RS resource set with one 1-port CSI-RS according to such a framework, while FIG. 10 illustrates an example CSI-RS resource set with two 1-port CSI-RS according to such a framework. In the illustrated scenario of FIG. 10, the field of ‘repetition’ in the CSI-RS resource set configuration may be enabled and accordingly the UE may assume the same CSI-RS port 3000 is repeated across the two 1-port CSI-RS resources for CSI acquisition.

For configurations with more than one 1-port CSI-RS resource in a CSI-RS resource set for CSI acquisition, there may be a variety of possible approaches that can be considered for a 2-port CSI-RS pattern for a reduced capability UE that is capable of up to 2 Rx chains and 2 downlink MIMO layers. In some instances, N (where N>1, e.g., with N=2 or N=4 as possible embodiments) 1-port CSI-RS resources with density ρ=3 may be configured for a CSI-RS resource set in the same slot. The UE may determine that the CSI-RS resource is transmitted using antenna ports numbered in a specified or configured manner. As one option, the following equation may be used.

$$p = 3000 + c mod 2$$

where c∈{0,1,2,3} represents the CSI-RS resource index within the CSI-RS resource set.

As another option, the CSI-RS resource elements (REs) may be first numbered in order of increasing frequency domain first and then increasing time domain. Then, the following equation may be used to determine the associated antenna port for a given resource element.

$$p = 3000 + s$$

where s=0 for even CSI-RS resource element indexes and s=1 for odd CSI-RS resource element indexes.

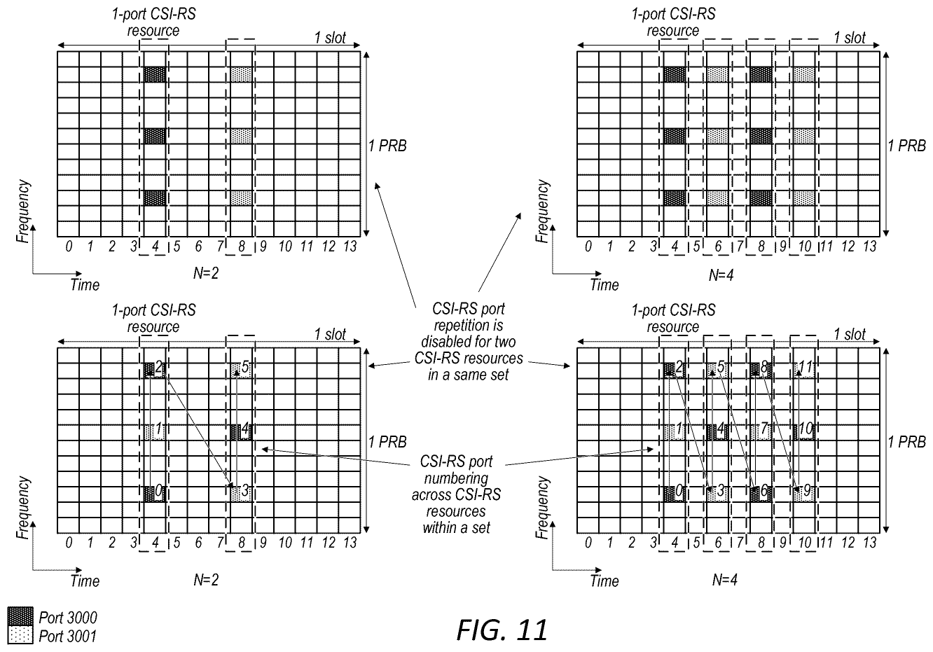

FIG. 11 illustrates examples of various such possible approaches, including for both of the example approaches to determining which CSI-RS resources are transmitted using which antenna ports described herein, and for scenarios in which N=2 and in which N=4, according to some embodiments.

Another approach to providing CSI-RS for CSI acquisition for reduced capability UEs may include performing repetitions of existing CSI-RS patterns. For example, the existing M-ports CSI-RS pattern shown in 3GPP TS 38.211 v.17.0.0 Table 7.4.1.5.3-1, e.g., for M≥2 may be used with a repetition number N. The value of N may be explicitly configured as part of the M-port CSI-RS configuration, or may be hard-encoded in 3GPP specifications, e.g., as N=2 or N=3, among various possibilities, to provide a similar CSI-RS sequence processing gain as for non-reduced capability NR UEs.

As one option, such repetitions may be configured for different subcarriers of a PRB in the frequency domain, and in the same symbol of a slot. An offset information element (IE) may be introduced to enable the intra-RB CSI-RS repetition in the frequency domain, which may indicate the subcarrier offset of the largest subcarrier of the repeated CSI-RS resource ‘i’ with respect to the largest subcarrier of the 2-ports RRC-configured CSI-RS resource. Thus, for example, the following equation could be used to determine subcarrier indexes of configured CSI-RS resources.

$${k}_{0}^{i} = {k}_{0} + {O}_{f} * i$$

where k₀ⁱ is the lowest subcarrier index of repeated CSI-RS resource ‘i,i>0’ and k₀ is the lowest subcarrier index of the RRC-configured CSI-RS resource. In some instances, the offset value ‘O_{f}’ may be explicitly indicated as part of CSI-RS configuration. In some instances, the offset value ‘O_{f}’ may be implicitly determined based on the repetition number N. For example, the offset value could be determined using the following equation.

$${O}_{f} = ⌊ {N}_{sc}^{RB} / N ⌋$$

If desired, the offset calculation may further be performed with mod 12, e.g., to ensure that the CSI-RS repetitions fall within the same PRB.

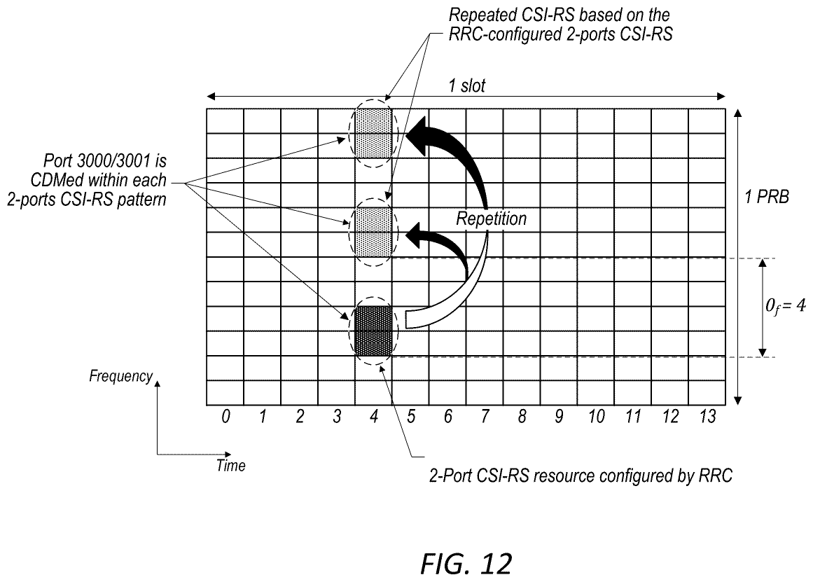

FIG. 12 illustrates one example of such intra-RB CSI-RS repetition with N=3 and O_{f}=4, where O_{f} is either explicitly configured by RRC signaling or implicitly determined using the example equation provided herein, at least according to some embodiments.

As another option, such repetitions may be configured for different symbols of a PRB in the time domain, and in the same subcarriers of a slot. An offset IE may be introduced to enable the intra-RB CSI-RS repetition in the time domain, which may indicate the symbol offset of the first symbol of the repeated CSI-RS resource with respect to the first symbol of the RRC-configured M-ports CSI-RS resource. Thus, for example, the following equation could be used to determine the first symbol of the repeated CSI-RS resource.

$${l}_{0}^{i} = {l}_{0} + {O}_{t} * i$$

where l₀ⁱ is the first symbol index of repeated CSI-RS resource ‘i,i>0’ and l₀ is the first symbol index of the RRC-configured CSI-RS resource. In some instances, the offset value ‘Oₜ’ may be explicitly indicated as part of CSI-RS configuration. In some instances, the offset value ‘Oₜ’ may be hard-encoded in 3GPP specifications or implicitly determined based on the repetition number N. For example, the offset value could be determined using the following equation.

$${O}_{f} = ⌊ {N}_{symb} / N ⌋$$

where N_{symb}=12 assuming two symbols are reserved for downlink control channels, e.g., PDCCH. If desired, the offset calculation may further be performed with mod 12, e.g., to ensure that the CSI-RS repetitions fall within the same slot.

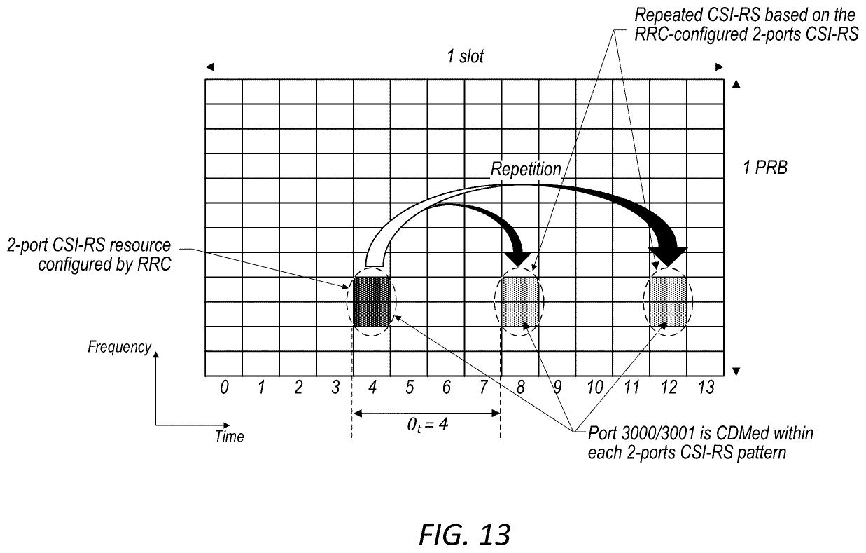

FIG. 13 illustrates one example of such intra-RB CSI-RS repetition with N=3, M=2, and Oₜ=4, where Oₜ is either explicitly configured by RRC signaling or implicitly determined using the example equation provided herein, at least according to some embodiments.

Note that in some designs, an information element may be introduced in CSI-RS configuration to select frequency domain repetition or time domain repetition for a given RRC-configured M-ports CSI-RS pattern.

As a still further option, such repetitions may be configured for different symbols of a PRB in the time domain, and in different subcarriers in the frequency domain, within a slot. Two offset IEs may be introduced to enable the intra-RB CSI-RS repetition in the time domain and in the frequency domain. The offsets (e.g., O_{f} and Oₜ) may be determined and used in a similar manner as described herein for the individual frequency domain repetition and time domain repetition options, at least according to some embodiments. Thus, for example, the following equations could be used to determine the repeated CSI-RS resource location.

$${k}_{0}^{i} = {k}_{0} + {O}_{f} * i \\ {l}_{0}^{i} = {l}_{0} + {O}_{t} * i$$

where the definitions of the parameters used in the equations are consistent with the comparable parameters of the frequency domain repetition and time domain repetition options previously described herein.

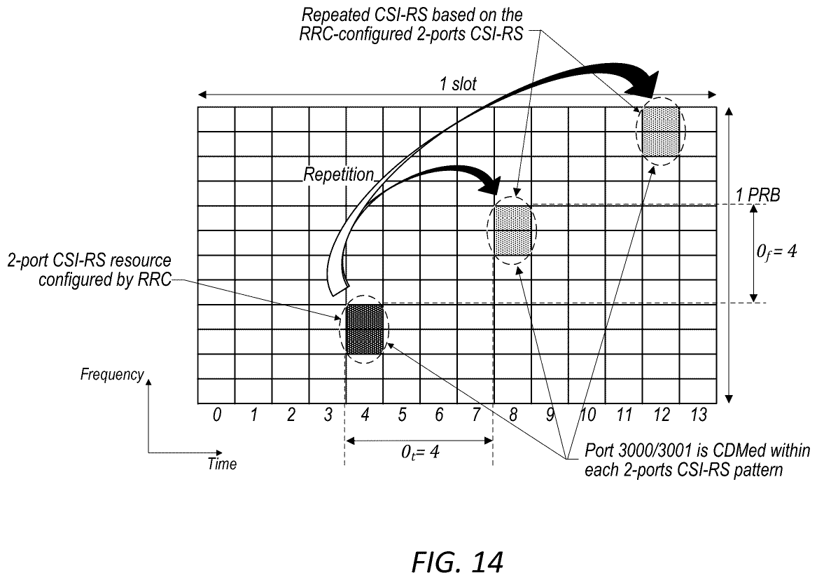

FIG. 14 illustrates one example of such intra-RB CSI-RS repetition with N=3, M=2, O_{f}=4, and Oₜ=4, at least according to some embodiments.

Note that, at least according to some embodiments, a UE may assume that antenna ports within a CSI-RS resource and its repeated CSI-RS resource are quasi co-located with QCL Type A, Type D (when applicable), and average gain.

A still further approach to providing CSI-RS for CSI acquisition for reduced capability UEs may include support for more flexible configuration (albeit potentially at a cost of increased signaling overhead) of the CSI-RS resources in a given slot. In such a design, a UE may be configured with more than one (“K”) 2 ports CSI-RS resources for CSI acquisition. A reduced capability UE being configured in such a manner may assume that antenna ports across all of the 2-ports CSI-RS resources are quasi co-located with QCL Type A, Type D (when applicable), and average gain. The aggregated 2-ports CSI-RS resources may be used for a single CSI computation and feedback.

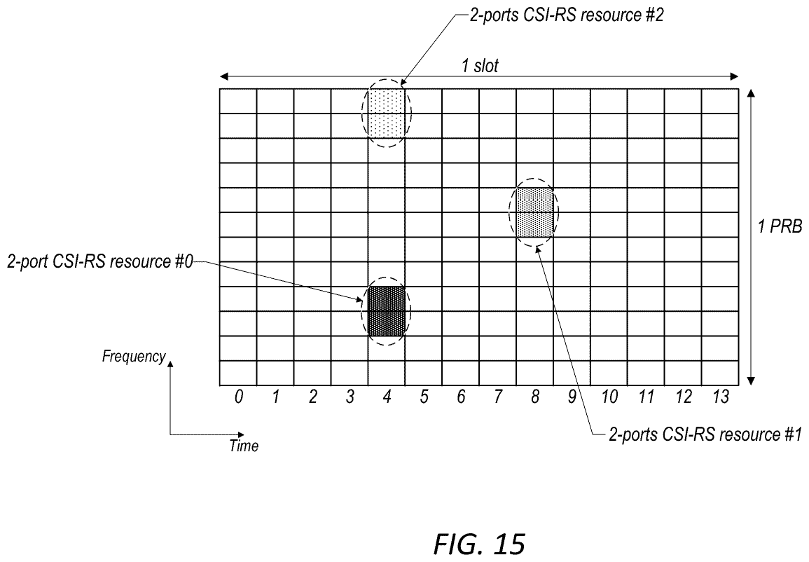

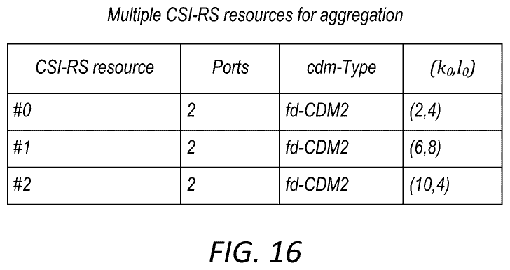

FIG. 15 illustrates an example CSI-RS pattern that could be configured in accordance with such a possible approach, according to some embodiments. FIG. 16 is a table showing the multiple CSI-RS resources configured for aggregation in the illustrated pattern of FIG. 15, according to some embodiments. As shown, in the illustrated scenario, 3 2-ports CSI-RS resources are configured, beginning at subcarrier 2 and symbol 4, subcarrier 6 and symbol 8, and subcarrier 10 and symbol 4.

In some designs, it may be possible to use the following approach by a reduced capability UE to determine the CSI-RS antenna ports (APs). First, an existing CSI-RS-ResourceMapping IE may be used to indicate the total number of RES Nₜₒₜₐₗ. A set of new IEs may be added into CSI-RS configuration for reduced capability UEs. Such IEs may include an IE to indicate the AP number for reduced capability UEs, represented as K. Such IEs may also include an IE to indicate the cdm-Type of Aps used by reduced capability UEs; alternatively, the cdm-Type may be fixed to be fd-CDM2 if K=2 and ‘noCDM’ if K=1, among various possibilities. The total REs configured (Nₜₒₜₐₗ) may be divided into S sub-groups:

$$S = {N}_{total} / {N}_{cdm} ,$$

where N_{cdm} is the CDM group size used for reduced capability UEs, which may be determined based on the cdm-Type obtained in the preceding step.

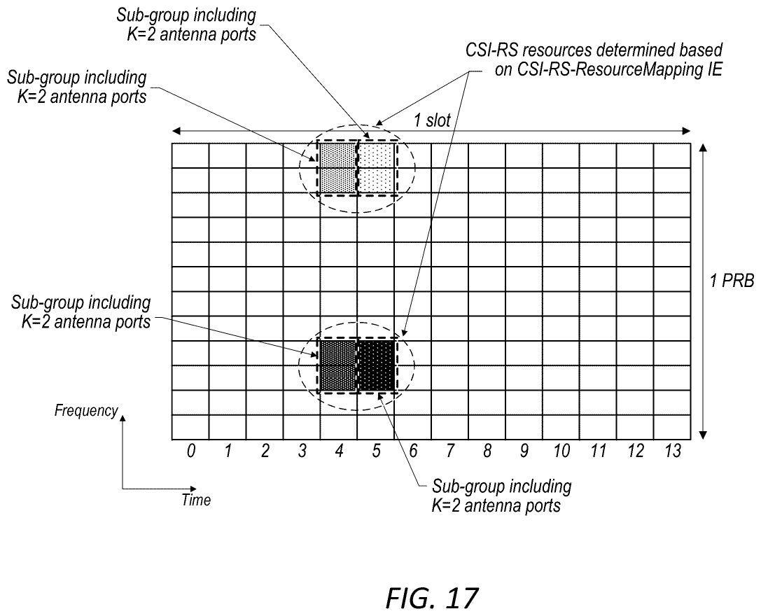

FIG. 17 illustrates one example of such a design, in which a CSI-RS-ResourceMapping IE indicates row index #8 for an 8-ports CSI-RS. Correspondingly, Nₜₒₜₐₗ=8 in the illustrated scenario. Further, in the illustrated scenario, K=2 (e.g., 2 APs for reduced capability UEs) with ‘fd-CDM2’. Correspondingly, a total of 4 sub-groups with each including K=2 APs are used in the scenario of FIG. 17.

In some instances, it may be possible that for a reduced capability UE with BWP that is smaller than 24 PRBs, the UE can be configured via higher layer signaling (e.g., RRC or MAC, as some possibilities) with one out of two possible subband sizes, where a subband is defined as N_{PRB}^{SB} contiguous PRBs. In some designs, the values of N_{PRB}^{SB} may be specified in 3GPP standard specifications; for example, possible values of N_{PRB}^{SB}=4,8 may be specified, as one possibility.

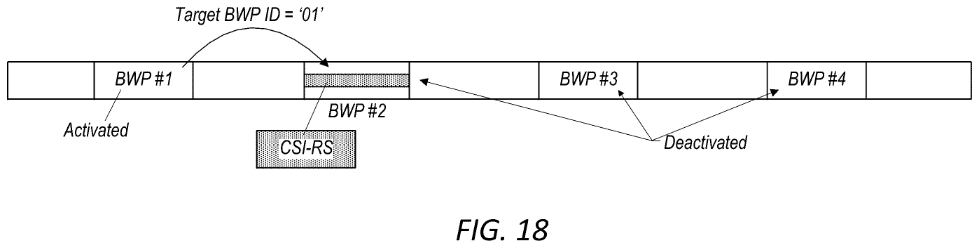

According to some embodiments, a ‘target BWP ID’ IE may be introduced, e.g., to support the possibility of configuring CSI acquisition measurements outside of an active BWP. Such an IE may be added into the downlink scheduling downlink control information to indicate the target BWP to which the CSI request IE is to be applied. For example, the target BWP ID may point to an active BWP or to a deactivated BWP for CSI measurement. FIG. 18 illustrates example aspects of such a feature, according to some embodiments. In the illustrated example, the ‘target BWP ID’ IE in a scheduling DCI on activated BWP #1 may be set to ‘01’ to trigger CSI-RS transmission and corresponding measurement on deactivated BWP #2. Note that as another possibility, for each CSI reporting configuration, a ‘target BWP ID’ may be added to indicate the associated BWP for the CSI reporting that is associated with a given ‘CSI request’ IE state.

In the following further exemplary embodiments are provided.

One set of embodiments may include a method, comprising: by a wireless device: establishing a wireless link with a cellular base station; receiving information configuring channel state information (CSI) acquisition for a bandwidth part (BWP); determining CSI reference signal (CSI-RS) resources for the CSI acquisition, wherein the CSI-RS resources include multiple resource elements per antenna port per physical resource block for the BWP; and performing CSI acquisition using the determined CSI-RS resources.

According to some embodiments, the CSI-RS resources for the CSI acquisition include one or more 1-port CSI-RS resources with density greater than one.

According to some embodiments, the CSI-RS resources for the CSI acquisition include at least two 1-port CSI-RS resources with density greater than one, wherein a ‘repetition’ parameter is enabled for the CSI-RS resources for the CSI acquisition, wherein a same antenna port is configured for the CSI-RS resources for the CSI acquisition based at least in part on the ‘repetition’ parameter being enabled for the CSI-RS resources for the CSI acquisition.

According to some embodiments, the CSI-RS resources for the CSI acquisition include at least two 1-port CSI-RS resources with density greater than one, wherein a ‘repetition’ parameter is disabled for the CSI-RS resources for the CSI acquisition, wherein different antenna ports are configured for different CSI-RS resources for the CSI acquisition based at least in part on the ‘repetition’ parameter being disabled for the CSI-RS resources for the CSI acquisition.

According to some embodiments, the CSI-RS resources for the CSI acquisition include a multi-port CSI-RS pattern with repetition configured in one or more of a frequency domain or a time domain.

According to some embodiments, a number of repetitions configured for the multi-port CSI-RS pattern is determined based on one or more of: an explicit indication included in the information configuring the CSI acquisition for the BWP; or the wireless device operating as a reduced capability category of wireless device.

According to some embodiments, the method further comprises: determining one or more offset values for repetitions of the multi-port CSI-RS pattern, wherein the offset values are determined based on one or more of: one or more explicit indications included in the information configuring the CSI acquisition for the BWP; or a number of repetitions configured for the multi-port CSI-RS pattern.

According to some embodiments, the CSI-RS resources for the CSI acquisition include at least two multi-port CSI-RS resources, wherein the information configuring the CSI acquisition for the BWP includes information explicitly indicating resource locations for the at least two multi-port CSI-RS resources, wherein performing channel state information acquisition using the determined CSI-RS resources includes aggregating measurements for the at least two multi-port CSI-RS resources for channel state information computation.

According to some embodiments, determining CSI-RS resources for the CSI acquisition further comprises: determining a total number and locations of resource elements per physical resource block based at least in part on a CSI-RS resource mapping information element (IE) included in the information configuring the CSI acquisition for the BWP; determining a number of antenna ports configured for the CSI-RS resources for the CSI acquisition based at least in part on an antenna port number IE included in the information configuring the CSI acquisition for the BWP; and determining which antenna port is associated with which resource element of the CSI-RS resources for the CSI acquisition based at least in part on the CSI-RS resource mapping IE and the antenna port number IE.

According to some embodiments, the information configuring the CSI acquisition for the BWP indicates a subband CSI acquisition for a subband size that is less than 24 physical resource blocks.

According to some embodiments, the information configuring the CSI acquisition for the BWP includes information indicating a target BWP identifier for the BWP, wherein the target BWP identifier indicates a BWP that is deactivated for the wireless device.

Another set of embodiments may include a wireless device, comprising: one or more processors; and a memory having instructions stored thereon, which when executed by the one or more processors, perform steps of the method of any of the preceding examples.

Still another set of embodiments may include a computer program product, comprising computer instructions which, when executed by one or more processors, perform steps of the method of any of the preceding examples.

Yet another set of embodiments may include a method, comprising: by a cellular base station: establishing a wireless link with a wireless device; providing information to the wireless device configuring channel state information (CSI) acquisition for a bandwidth part (BWP), wherein CSI reference signal (CSI-RS) resources for the CSI acquisition include multiple resource elements per antenna port per physical resource block for the BWP; and receiving CSI reporting for the BWP from the wireless device.

According to some embodiments, the CSI-RS resources for the CSI acquisition include one or more 1-port CSI-RS resources with density greater than one.

According to some embodiments, the CSI-RS resources for the CSI acquisition include a multi-port CSI-RS pattern with repetition configured in one or more of a frequency domain or a time domain.

According to some embodiments, the CSI-RS resources for the CSI acquisition include at least two multi-port CSI-RS resources, wherein the information configuring the CSI acquisition for the BWP includes information explicitly indicating resource locations for the at least two multi-port CSI-RS resources, wherein the CSI reporting is based on aggregated measurements for the at least two multi-port CSI-RS resources.

According to some embodiments, the information configuring the CSI acquisition for the BWP includes a CSI-RS resource mapping information element (IE), wherein the CSI-RS resource mapping IE indicates a total number and locations of resource elements per physical resource block for the BWP; wherein the information configuring the CSI acquisition for the BWP includes an antenna port number IE, wherein the antenna port number IE indicates a number of antenna ports configured for the CSI-RS resources for the CSI acquisition.

According to some embodiments, the information configuring the CSI acquisition for the BWP indicates one or more of: a subband CSI acquisition for a subband size that is less than 24 physical resource blocks; or a target BWP identifier for the BWP.

A further set of embodiments may include a cellular base station, comprising: one or more processors; and a memory having instructions stored thereon, which when executed by the one or more processors, perform steps of the method of any of the preceding examples.

A still further set of embodiments may include a computer program product, comprising computer instructions which, when executed by one or more processors, perform steps of the method of any of the preceding examples.

A further exemplary embodiment may include a method, comprising: performing, by a wireless device, any or all parts of the preceding examples.

Another exemplary embodiment may include a device, comprising: an antenna; a radio coupled to the antenna; and a processing element operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

Still another exemplary set of embodiments may include an apparatus comprising a processor configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method for operation in wireless communication, comprising:
receiving information configuring channel state information (CSI) acquisition for a bandwidth part (BWP);
determining CSI reference signal (CSI-RS) resources for the CSI acquisition, wherein the CSI-RS resources include multiple resource elements per antenna port per physical resource block for the BWP; and
performing CSI acquisition using the determined CSI-RS resources.

2. The method of claim 1,
wherein the CSI-RS resources for the CSI acquisition include one or more 1-port CSI-RS resources with density greater than one.

3. The method of claim 2,
wherein the CSI-RS resources for the CSI acquisition include at least two 1-port CSI-RS resources with density greater than one, wherein a ‘repetition’ parameter is enabled for the CSI-RS resources for the CSI acquisition, wherein a same antenna port is configured for the CSI-RS resources for the CSI acquisition based at least in part on the ‘repetition’ parameter being enabled for the CSI-RS resources for the CSI acquisition.

4. The method of claim 2,
wherein the CSI-RS resources for the CSI acquisition include at least two 1-port CSI-RS resources with density greater than one, wherein a ‘repetition’ parameter is disabled for the CSI-RS resources for the CSI acquisition, wherein different antenna ports are configured for different CSI-RS resources for the CSI acquisition based at least in part on the ‘repetition’ parameter being disabled for the CSI-RS resources for the CSI acquisition.

5. The method of claim 1,
wherein the CSI-RS resources for the CSI acquisition include a multi-port CSI-RS pattern with repetition being configured in one or more of a frequency domain or a time domain.

6. The method of claim 5,
wherein a number of repetitions configured for the multi-port CSI-RS pattern is determined based on one or more of:
an explicit indication included in the information configuring the CSI acquisition for the BWP; or
a value predefined in a technical specification for a wireless device operating as a reduced capability device.

7. The method of claim 5, wherein the method further comprises:
determining one or more offset values for repetitions of the multi-port CSI-RS pattern, wherein the offset values are determined based on one or more of:
one or more explicit indications included in the information configuring the CSI acquisition for the BWP; or
a number of repetitions configured for the multi-port CSI-RS pattern.

8. The method of claim 1,
wherein the CSI-RS resources for the CSI acquisition include at least two multi-port CSI-RS resources,
wherein the information configuring the CSI acquisition for the BWP includes information explicitly indicating resource locations for the at least two multi-port CSI-RS resources,
wherein performing channel state information acquisition using the determined CSI-RS resources includes aggregating at least two multi-port CSI-RS resources for channel state information computation.

9. The method of claim 1, wherein determining CSI-RS resources for the CSI acquisition further comprises:
determining a total number and locations of resource elements per physical resource block based at least in part on a CSI-RS resource mapping information element (IE) included in the information configuring the CSI acquisition for the BWP;
determining a number of antenna ports configured for the CSI-RS resources for the CSI acquisition based at least in part on an antenna port number IE included in the information configuring the CSI acquisition for the BWP; and
determining which antenna port is associated with which resource element of the CSI-RS resources for the CSI acquisition based at least in part on the CSI-RS resource mapping IE and the antenna port number IE.

10. The method of claim 1,
wherein the information configuring the CSI acquisition for the BWP indicates a subband CSI acquisition for a subband size that is less than 24 physical resource blocks.

11. The method of claim 1,
wherein the information configuring the CSI acquisition for the BWP includes information indicating a target BWP identifier for the BWP,
wherein the target BWP identifier indicates a BWP that is deactivated.

12-20. (canceled)

21. A processor comprising memory configured to cause the processor to:
receive information configuring channel state information (CSI) acquisition for a bandwidth part (BWP);
determine CSI reference signal (CSI-RS) resources for the CSI acquisition, wherein the CSI-RS resources include multiple resource elements per antenna port per physical resource block for the BWP; and
perform CSI acquisition using the determined CSI-RS resources.

22. The processor of claim 21, wherein the CSI-RS resources for the CSI acquisition include at least one of:
one or more 1-port CSI-RS resources with density greater than one;
a multi-port CSI-RS pattern with repetition being configured in one or more of a frequency domain or a time domain; or
at least two multi-port CSI-RS resources, wherein the information configuring the CSI acquisition for the BWP includes information explicitly indicating resource locations for the at least two multi-port CSI-RS resources.

23. The processor of claim 21, wherein to determine CSI-RS resources for the CSI acquisition, the memory is further configured to cause the processor to:
determine a total number and locations of resource elements per physical resource block based at least in part on a CSI-RS resource mapping information element (IE) included in the information configuring the CSI acquisition for the BWP;
determine a number of antenna ports configured for the CSI-RS resources for the CSI acquisition based at least in part on an antenna port number IE included in the information configuring the CSI acquisition for the BWP; and
determine which antenna port is associated with which resource element of the CSI-RS resources for the CSI acquisition based at least in part on the CSI-RS resource mapping IE and the antenna port number IE.

24. A cellular base station, comprising:
one or more processors; and
a memory having instructions stored thereon, which when executed by the one or more processors, cause the cellular base station to:
provide information to a wireless device configuring channel state information (CSI) acquisition for a bandwidth part (BWP),
wherein CSI reference signal (CSI-RS) resources for the CSI acquisition include multiple resource elements per antenna port per physical resource block for the BWP; and
receive CSI reporting for the BWP from the wireless device.

25. The cellular base station of claim 24,
wherein the CSI-RS resources for the CSI acquisition include one or more 1-port CSI-RS resources with density greater than one.

26. The cellular base station of claim 24,
wherein the CSI-RS resources for the CSI acquisition include a multi-port CSI-RS pattern with repetition configured in one or more of a frequency domain or a time domain.

27. The cellular base station of claim 24,
wherein the CSI-RS resources for the CSI acquisition include at least two multi-port CSI-RS resources,
wherein the information configuring the CSI acquisition for the BWP includes information explicitly indicating resource locations for the at least two multi-port CSI-RS resources,
wherein the CSI reporting is based on at least two aggregated multi-port CSI-RS resources.

28. The cellular base station of claim 24,
wherein the information configuring the CSI acquisition for the BWP includes a CSI-RS resource mapping information element (IE), wherein the CSI-RS resource mapping IE indicates a total number and locations of resource elements per physical resource block for the BWP;
wherein the information configuring the CSI acquisition for the BWP includes an antenna port number IE, wherein the antenna port number IE indicates a number of antenna ports configured for the CSI-RS resources for the CSI acquisition.

29. The cellular base station of claim 24,
wherein the information configuring the CSI acquisition for the BWP indicates one or more of:
a subband CSI acquisition for a subband size that is less than 24 physical resource blocks; or
a target BWP identifier for the BWP.
